(19) United States
(12) Patent Application Publication
(10) Pub. No.: US 2026/0049556 A1
(43) Pub. Date: Feb. 19, 2026

(54) ROUGHNESS AUGMENTED COOLING FOR GAS TURBINE ENGINES

(71) Applicant: RTX Corporation, Farmington, CT (US)

(72) Inventors: Peter Hansen WILKINS, Manchester, CT (US); Alex J. SCHNEIDER, Manchester, CT (US); Tyler G. VINCENT, Portland, CT (US); Richard Wesley JACKSON, III, Mystic, CT (US)

(73) Assignee: RTX Corporation, Farmington, CT (US)

(21) Appl. No.: 18/806,343

(22) Filed: Aug. 15, 2024

(51) Int. Cl. F01D 5/18; F01D 5/28

(52) U.S. Cl. CPC F01D 5/187; F01D 5/282; F05D 2220/32; F05D 2230/90; F05D 2300/6033

(57) ABSTRACT

A component for a gas turbine engine includes a cavity configured to receive cooling air bled from a compressor of the gas turbine. The component further includes a portion of the component subject to elevated temperatures during operation of the gas turbine engine. To provide convective-type cooling to the hot portion, at least one cooling air passage is manufactured to extend from the cavity and pass through the portion of the component. The at least one cooling air passage has an intentionally roughened surface resulting from manufacture that augments convection-based cooling of the portion of the component. The component may be metallic or a ceramic matrix composite (CMC) and the intentionally roughened surface may have a surface roughness that results in a surface roughness average to cooling passage diameter ratio (Rₐ/D) in a range of approximately 0.02-0.1.

### FIELD OF THE INVENTION

The subject matter disclosed herein relates to gas turbine engine components and, in particular, to manufacturing a roughened surface into a cooling air passage to augment cooling of a turbine engine component during use.

### BACKGROUND OF THE INVENTION

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section may include low- and high-pressure compressors, and the turbine section may also include low-and high-pressure turbines.

Ceramic matrix composites (“CMC”) are being used for certain gas turbine engine components, and have usefulness in other fields as well. For instance, CMCs can be employed for airfoils in the combustor or turbine sections of a gas turbine engine. Among other attractive properties, CMCs have low density and high temperature capability, which is important for gas turbine use.

For example, to run at maximum efficiency, turbine engines often experience temperatures of more than 2000 degrees Kelvin, and these elevated temperatures can lead to compromised integrity and failure of the blades or vanes. One method for addressing this problem is to cool the blades or vanes using film cooling in which, for example, cool air is bled from the compressor, ducted to one or more internal chambers of the turbine components (blades, vanes, and/or blade outer air seals (BOAS)/shrouds), and discharged through one or more cooling apertures to provide a thin layer (i.e., a “film”) that reduces heat transfer from the main flow so that convective heat transfer to the surface of the turbine blade can be reduced. However, due to airflow and/or geometry constraints, there are areas where film cooling is difficult or impossible to implement. Accordingly, cooling such areas must rely upon other cooling schemes such as impingement-based or convection-based cooling.

While gas turbine engine components composed of CMCs can sustain operating temperatures hundreds of degrees higher than gas turbine engine components composed of metal alloys, they also have a lower thermal conductivity than metal alloys. The low thermal conductivity of CMCs may decrease the effectiveness of impingement-based, convection-based, and other cold wall-based cooling schemes.

Surface roughness on gas turbine components is generally considered to have a negative impact on several aspects within a gas turbine, including reducing aerodynamic performance, reducing film cooling performance, and affecting heat transfer in undesirable regions resulting in a lower performing component. Indeed, with respect to cooling apertures used for film cooling, it is typically desirable for the meter and diffusion portions of such cooling apertures to have smooth surfaces.

The above information disclosed in this Background section is only for understanding of the background of the inventive concepts and, therefore, it may contain information that does not constitute prior art.

### SUMMARY OF THE INVENTION

The present disclosure is directed, in a first aspect, to a component for a gas turbine engine. The component includes a cavity configured to receive cooling air bled from a compressor of the gas turbine engine, and a portion of the component that is subject to elevated temperatures during operation of the gas turbine engine. At least one cooling air passage is manufactured to extend from the cavity and pass through the portion of the component, wherein the at least one cooling air passage has an intentionally roughened surface resulting from manufacture that augments convection-based cooling of the portion of the component.

In an embodiment, the component may be metallic.

In another embodiment, the intentionally roughened surface of the metallic component may have a surface roughness that results in a surface roughness average to cooling passage diameter ratio (Rₐ/D) in a range of approximately 0.02-0.1.

In a further embodiment, the component may be formed of ceramic matrix composite (CMC).

In yet another embodiment, the component may be an airfoil and the portion of the component may be a trailing edge of the airfoil.

In an embodiment, the intentionally roughened surface of the component may have a surface roughness that results in a surface roughness average to cooling passage diameter ratio (Rₐ/D) in a range of approximately 0.02-0.1.

In a further embodiment, the component may be a ceramic matrix composite (CMC) airfoil and the portion of the component may be a trailing edge of the airfoil.

In yet another embodiment, the at least one cooling air passage in the CMC airfoil may include a plurality of cooling air passages spaced apart from one another and extending from the cavity to the trailing edge of the airfoil.

In an embodiment, the plurality of cooling air passages in the CMC airfoil may be substantially parallel and extend substantially orthogonal to the trailing edge of the airfoil.

In an embodiment, the portion of the component may be subject to airflow and/or geometry constraints that prevent use of film cooling.

The present disclosure is directed, in another aspect, to a method of making a component with augmented cooling for a gas turbine engine. The method includes forming the component with a cavity configured to receive cooling air bled from a compressor of the gas turbine, and manufacturing at least one cooling air passage extending from the cavity and passing through a portion of the component subject to elevated temperatures during operation of the gas turbine engine, wherein the at least one cooling air passage has an intentionally roughened surface resulting from the manufacturing that augments convection-based cooling of the portion of the component.

In an embodiment of the method, the component may be formed of metal alloy.

In another embodiment of the method, the intentionally roughened surface may have a surface roughness that results in a surface roughness average to cooling passage diameter ratio (Rₐ/D) in a range of approximately 0.02-0.1.

In a further embodiment of the method, the component may be formed of ceramic matrix composite (CMC).

In yet another embodiment, the formed component may be an airfoil and the portion of the component may be a trailing edge of the airfoil.

In an embodiment of the method, the intentionally roughened surface may have a surface roughness that results in a surface roughness average to cooling passage diameter ratio (Rₐ/D) in a range of approximately 0.02-0.1.

In another embodiment of the method, the component may be a ceramic matrix composite (CMC) airfoil, and the portion of the component is a trailing edge of the airfoil.

In an embodiment, the step of manufacturing the at least one cooling air passage may include manufacturing a plurality of cooling air passages spaced apart from one another and extending from the cavity to the trailing edge of the airfoil.

The present disclosure is directed, in a further aspect, to a ceramic matrix composite (CMC) airfoil. The CMC airfoil includes a cavity configured to receive cooling air bled from a compressor of the gas turbine, a leading edge and a trailing edge, and a plurality of cooling air passages extending from the cavity and passing through the airfoil to the leading edge and/or the trailing edge of the airfoil, wherein the plurality of cooling air passages has an intentionally roughened surface resulting from manufacture that augments convection-based cooling of the leading edge and/or the trailing edge.

In an embodiment of the CMC airfoil, the plurality of cooling air passages may be machined through the leading edge and/or the trailing edge to the cavity with predetermined tooling at a predetermined speed and/or feed rate such that the intentionally roughened surface has a surface roughness that results in a surface roughness average to cooling passage diameter ratio (Rₐ/D) in a range of approximately 0.02-0.1.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 is a schematic view of an example gas turbine engine component in accordance with the present invention.

FIG. 2 is a perspective view an example airfoil component in accordance with the present invention.

FIG. 3 is a sectional (cut-away) view of the airfoil component of FIG. 2.

FIG. 4 is a diagram of an example process flow for making a gas turbine engine component in accordance with the present invention.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

The following discussion omits or only briefly describes conventional features of the disclosed technology that are apparent to those skilled in the art. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an,” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

Various examples of the disclosed technology are provided throughout this disclosure. The use of these examples is illustrative only, and in no way limits the scope and meaning of the invention or of any exemplified form. Likewise, the invention is not limited to any particular preferred embodiments described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

The devices of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting.

The present disclosure is directed to a gas turbine engine component including at least one intentionally rough cooling passage which is strategically positioned on and/or in the material making up a gas turbine engine component in order to augment convective cooling. In some cases, the augmented convective cooling may be accomplished without sacrificing other performance parameters. In other cases, embodiments of the present invention may improve or reduce performance, and in still further embodiments, a service life of a component may be improved with little to no cost to performance.

Within a gas turbine engine, the surface of various components can become rough through several mechanisms. These mechanisms may include, for example, dirt deposition, material degradation, and manufacturing limitations creating surface roughness on the components. Generally, as discussed above, roughness has been thought to be detrimental to gas turbine performance. However, it has been found that roughness can be beneficial if properly accounted for in regions where heat transfer augmentation is needed and where airflow and/or geometric constraints prevent use of impingement-based cooling or film cooling.

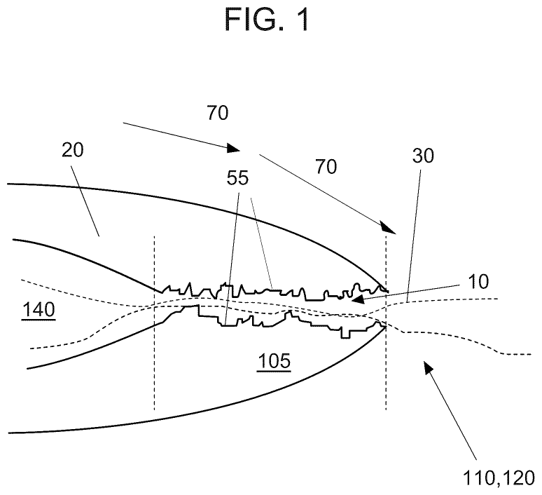

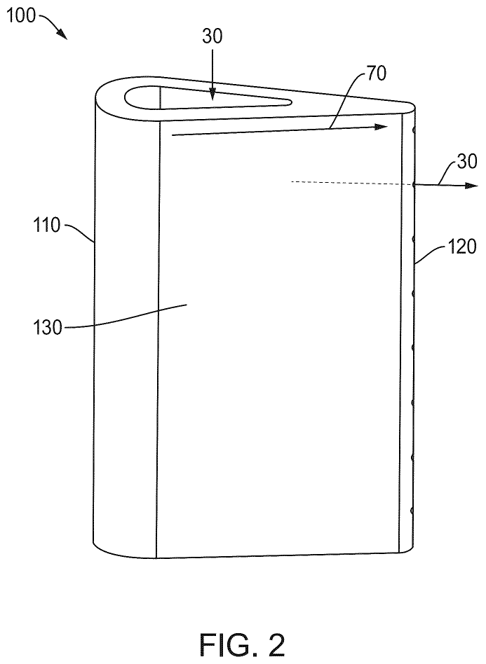

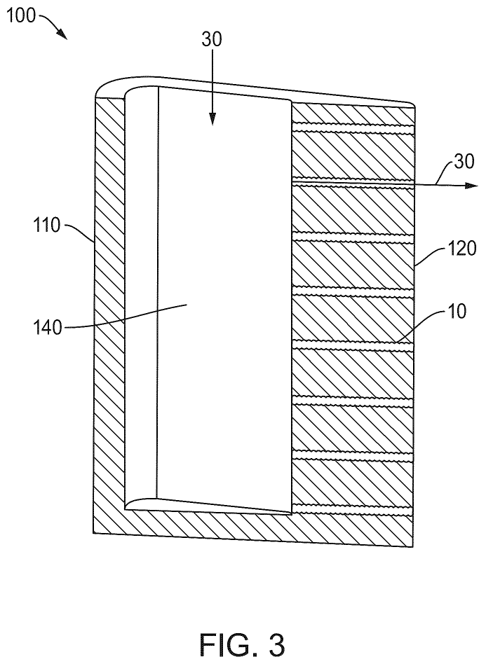

With reference to FIG. 1, an embodiment of a component 20 for a gas turbine engine in accordance with the present disclosure is illustrated schematically. The component 20 may be formed of a metal alloy or may be formed of CMC. A hot gas flow 70 from the gas turbine engine may flow over component 20 and heat up a portion 105 of component 20. If portion 105 of component 20 is disposed in a stagnant region such as a leading edge 110 or a trailing edge 120 of an airfoil 100 (see, e.g., FIGS. 2 and 3), typical film cooling techniques may be difficult or impossible to implement.

In one or more embodiments, component 20 includes a cavity 140 that may be configured to receive cooling air 30 bled from a compressor of the gas turbine engine. One or more cooling air passage(s) 10 may be manufactured into component 20. Thus, at least one cooling air passage 10 may extend from the cavity 140 and pass through the portion 105 of the component 20 to remove heat. In accordance with the present disclosure, the at least one cooling air passage 10 has an intentionally roughened surface 55 resulting from manufacture of the cooling air passage 10. The roughened surface 55 increases the surface area and causes turbulence/mixing. This serves to increase heat transfer to the cooling air 30 so as to augment convection-based cooling of the portion 105 of the component 20 when cooling air 30 passes from cavity 140 through the cooling air passage 10.

The roughened surface 55 as illustrated in FIG. 1 is not to scale and is exaggerated to indicate that the cooling air passage 10 does not have typical smooth walls. Various manufacturing techniques may be used to intentionally cause the resulting surface 55 to be rough. For example, when component 20 is made of metal alloy, a rough machining process may use a rotating tip at a feed rate and rotation speed that results in intentional gouges in the sidewalls. With respect to “feed”, “feed” is the rate at which, e.g., a drilling or milling instrument is inserted into a material. With respect to “speed”, “speed” is the rotations per minute or rpm at which, e.g., a drilling or milling instrument is operated. With this knowledge of “feed” and “speed”, also known as, “speed to feed”, the machining technique can be performed so as to impart a desired amount of intentional gouging of the sidewalls of the cooling air passage 10.

Where a typical machining or computer numerical control (CNC) process may provide a passage with a surface roughness of approximately 3.2 micro-meter (125 micro-inches) Rₐ, a manufacturing process in accordance with the present invention may result in a surface roughness equal to or greater than 6.3 micro-meter (250 micro-inches) Rₐ, for example, in a case where the cooling passage 10 has a small mean diameter of 10 mil (254 μm). For a larger cooling passage 10 with a 20 mil (508 μm) mean diameter, a manufacturing process in accordance with the present invention may result, for example, in a surface roughness equal to or greater than 12.5 micro-meter (500 micro-inches) Rₐ. For cooling passages 10 with a mean diameter of 30 mil (762 μm), a manufacturing process in accordance with the present invention may result, for example, in a surface roughness equal to or greater than 19 micro-meter (750 micro-inches) Rₐ. As used herein, roughness Rₐ (roughness average) refers to the arithmetic mean of the absolute values of the surface height deviations from the mean line, within a specified evaluation length.

Indeed, with smaller cooling passage 10 diameters, the roughness has a greater relative effect on convective heat transfer from the component 20 to the cooling air 30. Accordingly, as a diameter of a cooling passage increases, a roughness average (Rₐ) should also be increased in order to maintain the same percentage of increased heat transfer. For example, a ratio of (surface) roughness average (Rₐ) to mean cooling passage diameter (D), i.e., Rₐ/D, in a range of approximately 0.02 to 0.1 may permit increases of heat transfer between 30% and 300% under proper conditions.

In an embodiment where component 20 is formed of CMC, a grinding drill, and in some cases a worn grinding drill, may be used at rotational speeds and feed rates that result in intentional exposure of pores and matrix in a manner to cause the intentional roughness of the passage surface 55. In another possible embodiment, a fabric ply may be used to form the passages and the resulting texture of the CMC after the ply is densified may cause sufficient roughness for roughened surface 55. Thus, in various embodiments, a manufacturing process in accordance with the present invention may result in a surface roughness average to cooling passage diameter ratio (Rₐ/D) in the CMC cooling air passage 10 equal to or greater than 0.02, which may increase heat transfer of the CMC component 20.

In a further possible embodiment, a laser may be used to progressively ablate the CMC to create the cooling passage 10. In yet another possible embodiment, a water jet may be directed at the surface being ablated by the laser to facilitate material removal. A suitable water jet guided laser apparatus is available from SYNOVA S.A., Duillier (Nyon), Switzerland.

In another embodiment, an electrode for an electro-discharge machining (EDM) may be used to create the cooling passage 10. In a further embodiment, a sacrificial rod (e.g., a textured graphite rod) may be embedded in the CMCs plies during processing, after which the rod may be removed to create a void space for the cooling passage 10. The shape of the rod may be tailored to impart a desired surface roughness on cooling passage 10 thus formed.

In another embodiment, the surface of the cooling passage 10 may be coated with a layer of material. This material may be deposited from a slurry or from a vapor phase. The roughness of deposited coating may be controlled in accordance with the present disclosure (e.g., based upon particle size of the solids in the slurry). For example, a slurry containing 50 micron SiC particles in colloidal SiO₂ may be deposited on the surface of the cooling passage 10. In some embodiments, a plurality of the above processes may be combined to achieve a roughness average to mean diameter (Rₐ/D) ratio for the cooling passage in accordance with the present disclosure. For example, a slurry coated cooling passage 10 may further be treated with a laser to increase the roughness. In general, the more roughness that may be imparted as a result of the manufacturing, the greater the augmentation of the convective heat transfer.

Referring to FIGS. 2 and 3, the component 20 of FIG. 1 may, in certain embodiments, be an airfoil 100 with a leading edge 110, a trailing edge 120, and a gas flow surface 130 therebetween. In this embodiment, the portion 105 of the component 20 from FIG. 1 may be, for example, the trailing edge 120 of the airfoil 100.

Airfoil 100 may include a cavity 140 as provided, for example, by machining or by a hollow shear tube resulting from using a mandrel to manufacture a CMC airfoil. Cavity 140 may receive cooling air 30 bled off of a compressor of the gas turbine engine. Cooling air 30 may then pass through one or more cooling air passages 10, wherein the intentionally roughened surface 55 (see FIG. 1) may provide increased convective-type cooling in comparison to a smooth cooling air passage. In the illustrated embodiment, a plurality of the cooling air passages 10 extend from cavity 140 to the trailing edge 120 of airfoil 100 to provide cooling of an area of a gas turbine engine component that typically is difficult to cool using film cooling due to the airflow and/or geometry constraints.

While FIG. 3 illustrates substantially parallel, evenly-spaced cooling air passages 10 extending substantially orthogonal to the trailing edge 120, embodiments are not limited thereto and the spacing and direction may vary in order to provide a desired cooling profile to the portion 105 being cooled. When drill-type tooling is used to manufacture the cooling air passages 10, they will typically be straight. However, when other manufacturing methods are used to provide the intentionally roughened surface, such as molding/layup, the cooling air passages 10 may include curves and/or angled segments.

In one or more embodiments, FIGS. 2 and 3 may correspond to a CMC airfoil 100. The CMC airfoil 100 includes the cavity 140 formed, for example, by a hollow shear tube or machining. Cavity 140 is configured to receive cooling air 30 bled from a compressor of the gas turbine. The CMC airfoil 100 includes a leading edge 110 and a trailing edge 120. While illustrating an embodiment for cooling the trailing edge 120, the same principles apply to cooling the leading edge 110.

The CMC airfoil 100 further includes a plurality of cooling air passages 10 extending from the cavity 140 of the shear tube and passing through the airfoil to the (leading edge 110 and/or) the trailing edge 120 of the CMC airfoil 100. Based upon the selected process to manufacture the cooling air passages, the plurality of cooling air passages 10 may have an intentionally roughened surface 55 (see FIG. 1) resulting from manufacture that augments convection-based cooling of the (leading edge 110 and/or) trailing edge 120.

In an embodiment, the plurality of cooling air passages 10 may be machined through the (leading edge 110 and/or) trailing edge 120 to the cavity 140 of the shear tube with predetermined tooling at predetermined operating conditions (rpm and/or feed rate) such that the intentionally roughened surface results in a surface roughness average to cooling passage diameter ratio (Rₐ/D) in a range of approximately 0.02-0.1.

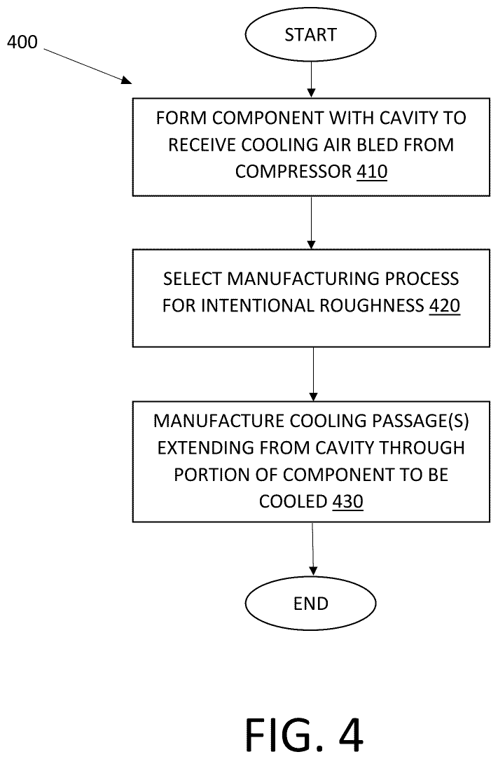

With reference to FIG. 4, a flow diagram of a method 400 of making a component with augmented cooling for a gas turbine engine is disclosed. Method 400 includes a step 410 of forming the component with a cavity configured to receive cooling air bled from a compressor of the gas turbine.

In order for the at least one cooling air passage 10 to have an intentionally roughened surface 55 resulting from the manufacturing that augments convection-based cooling of the portion of the component, an appropriate manufacturing process must be selected. Thus, method 400 includes a step 420 of selecting a manufacturing process to provide the intentional roughness. When machining is being used, selection of a tool, a rotation speed, and a feed rate may be involved. In one or more embodiment, a manufacturing method may be determined empirically based upon testing multiple variables (e.g., tool, tool wear, rpm, feed rate, laser power, etc.), may be based upon data collected when machining other parts, and/or may be extrapolated from either of the empirical or historical data.

Method 400 further includes step 430, which involves manufacturing at least one cooling air passage 10 extending from the cavity 140 and passing through a portion 105 of the component subject to elevated temperatures during operation of the gas turbine engine.

In many cases, since the machining is intended to be rough, the process of manufacturing the cooling air passages 10 can be done cheaper and/or faster than typical methods that would result in a smooth passage. Moreover, when a worn tool is used, it provides an additional use for a tool that was considered useless.

While an embodiment to a gas turbine engine airfoil has been disclosed, embodiments are not limited thereto and the present disclosure may also be applied to blade outer air seals/shrouds (BOAS) and/or combustor panels.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

1. A component for a gas turbine engine, comprising:
a cavity configured to receive cooling air bled from a compressor of the gas turbine engine;
a portion of the component subject to elevated temperatures during operation of the gas turbine engine;
at least one cooling air passage extending from the cavity and passing through the portion of the component,
wherein the at least one cooling air passage has a mean diameter D and an intentionally roughened surface resulting from manufacture that augments convection-based cooling of the portion of the component, and
wherein the intentionally roughened surface has a surface roughness that results in a surface roughness average Rₐ to cooling passage mean diameter ratio (Rₐ/D) in a range of approximately 0.02-0.1.

2. The component of claim 1, wherein the component is metallic.

3. (canceled)

4. The component of claim 1, wherein the component is formed of ceramic matrix composite (CMC).

5. The component of claim 1, wherein the component is an airfoil and the portion of the component is a trailing edge of the airfoil.

6. (canceled)

7. The component of claim 1, wherein the component is a ceramic matrix composite (CMC) and the portion of the component is a trailing edge of the airfoil.

8. The component of claim 7, wherein the at least one cooling air passage comprises a plurality of cooling air passages spaced apart from one another and extending from the cavity to the trailing edge of the airfoil.

9. The component of claim 8, wherein the plurality of cooling air passages is substantially parallel and extends substantially orthogonal to the trailing edge of the airfoil.

10. The component of claim 1, wherein the portion of the component is subject to airflow and/or geometry constraints that prevent use of film cooling.

11. A method of making a component with augmented cooling for a gas turbine engine, comprising:
forming the component with a cavity configured to receive cooling air bled from a compressor of the gas turbine; and
manufacturing at least one cooling air passage extending from the cavity and passing through a portion of the component subject to elevated temperatures during operation of the gas turbine engine,
wherein the at least one cooling air passage has a mean diameter D and an intentionally roughened surface resulting from the manufacturing that augments convection-based cooling of the portion of the component, and
wherein the intentionally roughened surface has a surface roughness that results in a surface roughness average Rₐ to cooling passage mean diameter ratio (Rₐ/D) in a range of approximately 0.02-0.1.

12. The method of claim 11, wherein the component is formed of metal alloy.

13. (canceled)

14. The method of claim 11, wherein the component is formed of ceramic matrix composite (CMC).

15. The method of claim 11, wherein the component is an airfoil and the portion of the component is a trailing edge of the airfoil.

16. (canceled)

17. The method of claim 11, wherein the component is a ceramic matrix composite (CMC) airfoil, and the portion of the component is a trailing edge of the airfoil.

18. The method of claim 17, wherein manufacturing the at least one cooling air passage comprises manufacturing a plurality of cooling air passages spaced apart from one another and extending from the cavity to the trailing edge of the airfoil.

19. A ceramic matrix composite (CMC) airfoil, comprising:
a cavity configured to receive cooling air bled from a compressor of the gas turbine;
a leading edge and a trailing edge; and
a plurality of cooling air passages extending from the cavity and passing through the airfoil to the leading edge and/or the trailing edge of the airfoil,
wherein the plurality of cooling air passages has a mean diameter D and an intentionally roughened surface resulting from manufacture that augments convection-based cooling of the leading edge and/or the trailing edge, and
wherein the plurality of cooling air passages is machined through the leading edge and/or the trailing edge to the cavity with predetermined tooling at a predetermined speed and/or feed rate such that the intentionally roughened surface has a surface roughness that results in a surface roughness average Rₐ to cooling passage mean diameter ratio (Rₐ/D) in a range of approximately 0.02-0.1.

20. (canceled)
